(19) United States
(12) Patent Application Publication
(10) Pub. No.: US 2026/0252377 A1
(43) Pub. Date: Aug. 27, 2026

(54) VIRTUAL FUNCTION BINDING BY A RUNTIME FOR ENHANCED RUNTIME PERFORMANCE

(71) Applicant: Microsoft Technology Licensing, LLC, Redmond, WA (US)

(72) Inventors: Jesse Tyler NATALIE, Redmond, WA (US); Jack Andrew ELLIOTT, Tauwhare (NZ)

(21) Appl. No.: 19/064,170

(22) Filed: Feb. 26, 2025

(51) Int. Cl. G06F 9/48

(52) U.S. Cl. CPC G06F 9/4806

(57) ABSTRACT

Methods and systems for creating a runtime object for bypassing a runtime and calling directly into a driver. A method includes receiving a call from an application requesting a runtime object, which includes a virtual function for issuing commands to a driver via the runtime. The method also includes creating the runtime object with a first member containing a pointer to a virtual function table in the runtime's memory space. This table maps the virtual function to a memory address in the driver's memory space, corresponding to a function implementation by the driver. Additionally, a second member includes a pointer to another memory address in the driver's memory space, corresponding to an internal driver object related to the runtime object. The method also includes returning a memory address corresponding to the runtime object to the application.

### BACKGROUND

In modern computing systems, applications often need to interact with various hardware components, such as graphics processing units (GPUs), sound cards, and other peripherals. To facilitate this interaction, services like DIRECT3D (D3D) from MICROSOFT CORPORATION act as intermediaries. These services provide standardized interfaces that allow applications to communicate with hardware drivers without knowing the specifics of the underlying hardware or the hardware driver. These abstractions ensure that applications can run on various hardware configurations without modification.

D3D, for example, is a graphics application programming interface (API) used in WINDOWS operating systems. D3D serves as a bridge between applications and a GPU driver. Thus, when an application issues a command to render graphics, it does so through the D3D API. D3D then processes this command and forwards it to the appropriate GPU driver. This process allows the application to remain hardware-agnostic, as it does not need to be aware of the specific GPU or driver it interacts with. Instead, D3D handles the complexities of interfacing with the hardware, providing a consistent and simplified interface for the application.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: receiving a call from an application, the call requesting a runtime object; creating the runtime object, the runtime object including: a first member including a first pointer to a virtual function table within a memory space of the runtime, the virtual function table mapping a virtual function for issuing a command to a driver via the runtime to a first memory address within a second memory space of the driver, the first memory address corresponding to a function implementation by the driver; and a second member including a second pointer to a second memory address within the second memory space of the driver, the second memory address corresponding to an internal driver object corresponding to the runtime object; and returning, to the application, a third memory address corresponding to the runtime object.

In some aspects, the techniques described herein relate to methods, systems, and computer program products, including: creating a virtual function table within a first memory space of the runtime, the virtual function table mapping a virtual function to a first memory address within a second memory space of a driver, the first memory address corresponding to a function implementation by the driver; receiving a call from an application, the call requesting a runtime object, the runtime object including the virtual function for issuing a command to the driver via the runtime; creating the runtime object, the runtime object including: a first member including a first pointer to the virtual function table; and a second member including a second pointer to a second memory address within the second memory space of the driver, the second memory address corresponding to an internal driver object corresponding to the runtime object; and returning, to the application, a third memory address corresponding to the runtime object.

In some aspects, the techniques described herein relate to methods, systems, and computer program products, including: creating a virtual function table within a first memory space of the runtime, the virtual function table mapping a virtual function to a first memory address within a second memory space of a driver, the first memory address corresponding to a function implementation by the driver; receiving a call from an application, the call requesting a runtime object, the runtime object including the virtual function for issuing a command to the driver via the runtime; calling the driver with a request for creating an internal driver object corresponding to the runtime object; receiving, from the driver, a second memory address within the second memory space of the driver, the second memory address corresponding to the internal driver object; creating the runtime object, the runtime object including: a first member including a first pointer to the virtual function table; and a second member including a second pointer to the second memory address; and returning, to the application, a third memory address corresponding to the runtime object.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates creating a runtime object for bypassing a runtime and calling directly into a driver;

FIG. 2 illustrates an example of a runtime that creates runtime objects for bypassing the runtime and calling directly into a driver;

FIG. 3 illustrates an example of a runtime translating calls from an application to a driver; and

FIG. 4 illustrates a flow chart of an example of a method for creating a runtime object for bypassing a runtime and calling directly into a driver.

### DETAILED DESCRIPTION

One significant challenge associated with using a runtime, like DIRECT3D (D3D), is the potential for performance impacts. The additional layer introduced by a runtime can lead to increased latency and processing overhead. Specifically, when an application issues a command through a runtime, the runtime often performs processing (e.g., to convert data, to convert calling conventions) and then forwards the command to a driver, such as a graphics processing unit (GPU) driver. In some situations, routing the command through the runtime introduces unnecessary overhead, as the command could potentially be sent directly to the driver without runtime processing. Even if the runtime performs no processing on the command, the mere act of routing the command through the runtime adds processing overheads and latency.

These overheads can be particularly noticeable in performance-critical applications, such as real-time graphics rendering in video games. Even minor runtime-induced delays can result in noticeable lag and reduced responsiveness in these scenarios. While providing valuable abstraction and compatibility, the runtime does not always contribute meaningful processing and can instead become a bottleneck. Therefore, optimizing the interaction between applications and hardware drivers by minimizing runtime overheads can lead to significant performance improvement.

At least some embodiments described herein leverage the use of virtual functions by runtimes, like D3D, to bind to specific virtual function implementations to in-driver functions. The invention leverages virtual tables (vtables) associated with these virtual functions to return runtime objects to calling applications, with these runtime objects pointing to a custom vtable (e.g., as their first member). This custom vtable includes entries that point directly into the driver (e.g., pointing to driver function implementations) rather than into the runtime (e.g., pointing to runtime function implementations). Consequently, an application can invoke these virtual functions as if the application were calling the runtime, but, due to the custom vtable, the application's calls are directed to the driver, bypassing the runtime. Notably, such calls have lower latency and require fewer processing resources than calls routed through the runtime, which improves application performance.

Notably, this approach can operate without altering the runtime application binary interface (ABI) expected by applications, because an object returned by the runtime still retains a pointer to a vtable, as anticipated (e.g., as the first member the object). As such, this approach works with existing applications and does not require applications to be modified to benefit from the performance enhancements enabled by this approach.

Additionally, at least some embodiments described herein can include an additional member in a runtime object returned by the runtime (e.g., as the second member of the object). In some examples, this additional member is a variable, field, or attribute of a class of which the runtime object is an instance. While the calling application may not recognize this additional member (e.g., because it is not part of the runtime ABI the application uses), the driver can utilize this additional member to obtain relevant information understood by the driver. In these embodiments, when a runtime creates a runtime object to be returned to a calling application, the runtime also requests that the driver create its own internal corresponding object. The driver creates an internal object and returns a pointer to this internal object to the runtime, and the runtime uses this pointer as this additional member of the runtime object returned to the calling application. Thus, when the application calls into the driver using a virtual function, dynamically mapped by the vtable into the driver, the driver can use this additional member in the runtime object to locate its own corresponding internal object. This enables the driver to obtain context that enables it to process calls that bypass the runtime.

Notably, while embodiments are described herein within an example context of a graphics runtime, such as D3D, it is noted that the principles described herein can apply to a variety of runtime types (e.g., graphics runtimes, audio runtime, storage runtimes) that act as an abstraction layer between a driver and an application using that driver. As such, unless expressly specified in the claims, reference herein to graphics runtimes, GPUs, and GPU drivers should not be construed as limiting to the scope or applicability of the claims.

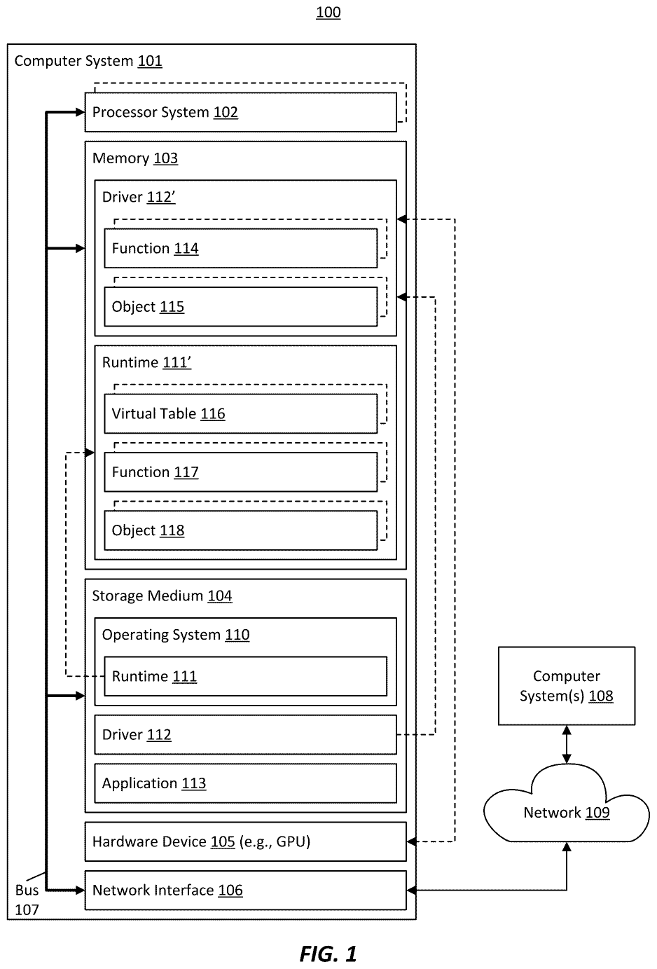

FIG. 1 illustrates an example 100 of computer architecture that facilitates creating a runtime object for bypassing a runtime and calling directly into a driver. As shown, the computer architecture includes a computer system 101 comprising computer hardware. In example 100, the computer hardware includes a processor system 102 (e.g., a single processor or a plurality of processors), a memory 103 (e.g., system or main memory), a storage medium 104 (e.g., a single computer-readable storage medium, or a plurality of computer-readable storage media), a hardware device 105 (e.g., a GPU), and a network interface 106 (e.g., for connecting to computer system(s) 108 via a network 109), all interconnected by a bus 107 (or a plurality of busses). Notably, the illustrated hardware is for illustrative purposes only and could vary. For example, computer system 101 may lack network interface 106, hardware device 105 may comprise network interface 106, and/or hardware device 105 may be something other than a GPU, such as a neural processing unit (NPU), an audio controller, or a storage controller.

FIG. 1 illustrates storage medium 104 as storing computer-executable instructions implementing an operating system (OS), OS 110, that includes a runtime component 111, a driver 112, and an application 113. The particular arrangement of OS 110, runtime component 111, driver 112, and application 113 may vary depending on implementation. For example, runtime component 111 may be separate from OS 110, driver 112 may be part of OS 110, and/or application 113 may be part of OS 110. FIG. 1 illustrates that, during operation, computer system 101 loads, among other things, the runtime component 111 and the driver 112 into memory 103. For example, one broken arrow connects runtime component 111 in storage medium 104 and loaded runtime 111′ in memory 103, and another broken arrow connects driver 112 in storage medium 104 and loaded driver 112′ in memory 103. A double-ended broken arrow that connects loaded driver 112′ in memory 103 and hardware device 105 indicates interactions between hardware device 105 and loaded driver 112′ (e.g., via bus 107).

In example 100, driver 112 facilitates interactions by other software with the hardware device 105. Additionally, the runtime component 111 provides an abstraction between applications (e.g., application 113) and driver 112. In one example, hardware device 105 is a GPU, driver 112 is a GPU driver, runtime component 111 is a graphics runtime such as D3D, and application 113 is a graphics application such as a game. In another example, hardware device 105 is an audio controller, driver 112 is an audio controller driver, runtime component 111 is an audio runtime, and application 113 is an application such as an audio mixer. Other examples are possible.

In general, runtime component 111 provides an application programming interface (API) and/or an ABI that enables applications, such as application 113, to call into runtime component 111 for interacting with driver 112 and, by extension, hardware device 105. Thus, runtime component 111 enables application 113 to interact with various drivers and hardware devices without having any foreknowledge of those particular drivers and hardware devices. Thus, runtime component 111 enables application 113 to interact with hardware and drivers that may not have even existed when application 113 was authored.

Conventionally, runtime components serve as intermediaries for commands issued from applications (e.g., application 113) and drivers (e.g., driver 112), providing processing such as command translation, data translation, and like features. However, in some scenarios, there is a subset of commands for which such processing is not needed. In these situations, runtime components still provide the benefit of abstracting the particulars of hardware drivers, such as an API exposed by a hardware driver, enabling applications to interact with hardware drivers without prior knowledge of the drivers. However, this abstraction comes at the cost of an extra layer between applications and hardware drivers.

In accordance with the embodiments herein, runtime component 111 retains the functionality of being an intermediary for commands issued from applications (e.g., application 113) and drivers (e.g., driver 112), including providing processing such as command translation, data translation, and like features. However, for an identified subset of commands for which such processing is unnecessary, the runtime component 111 utilizes new techniques to remove itself as an extra layer between applications and drivers. Notably, even though these embodiments enable applications to call directly into drivers, these embodiments still enable applications to be driver-agnostic, relying on APIs/ABIs provided by runtime component 111 rather than APIs/ABIs provided by driver 112.

In embodiments, runtime component 111 configures a runtime object that it returns to an application such that calls made by the application based on the runtime object are routed to the driver 112 rather than the runtime component 111. Thus, the runtime component 111 effectively removes itself as an extra layer between applications (e.g., application 113) and drivers (driver 112). In particular, the runtime component 111 returns, to an application, a runtime object that includes a virtual function (or a plurality of virtual functions) executable by the application, and that refers to a custom vtable that maps virtual functions to driver-implemented functions rather than runtime-implemented functions. As such, when the application calls a virtual function from this runtime object, the custom vtable causes the application to call the driver-implemented function rather than a runtime-implemented function as is typical.

For example, in example 100, loaded runtime 111′ includes virtual table 116 (or a plurality of virtual tables), function 117 (or a plurality of functions), and object 118 (or a plurality of objects). Additionally, loaded driver 112′ includes function 114 (or a plurality of functions) and object 115 (or a plurality of objects). In example 100, object 118 is a runtime object created by loaded runtime 111′ and returned (e.g., by reference) to application 113 based on a request from application 113. In one example, runtime component 111 is the D3D runtime, object 118 is a CommandList object returned by loaded runtime 111′ to application 113 based on a request from application 113 for a CommandList. In embodiments, object 118 defines a virtual function callable by application 113, with virtual table 116 being a custom virtual table that defines that virtual function to map to a memory address of function 114 within loaded driver 112′ (e.g., rather than mapping to function 117 within loaded runtime 111′, as would be typical). Thus, when application 113 calls this virtual function, this mapping in virtual table 116 causes application 113 to call function 114 within loaded driver 112′ directly. In embodiments, object 118 also contains a reference to a memory location of object 115, with object 115 being the driver-specific context for object 118. Thus, when loaded driver 112′ receives the call from application 113 to function 114, the loaded driver 112′ can use object 115 to understand and process the call.

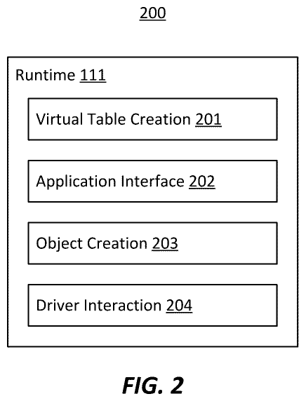

FIG. 2 illustrates an example 200 of the runtime component 111 of FIG. 1. Each component of runtime component 111 depicted in FIG. 2 represents various functionalities that runtime component 111 may implement under the embodiments described herein. These components—including their identity and arrangement—are presented merely as an aid in describing example embodiments of runtime component 111.

In embodiments, a virtual table creation component 201 manages one or more vtables at loaded runtime 111′. In one example, virtual table creation component 201 creates a single vtable. In this example, that single vtable may include mappings to both runtime functions (e.g., function 117 within loaded runtime 111′) as well as driver functions (e.g., function 114 within loaded driver 112′). For example, this vtable may map some virtual functions to runtime functions while mapping other virtual functions to driver functions. In another example, virtual table creation component 201 creates a plurality of vtables. In this example, the scope of each vtable may vary. For example, there could be a global vtable that includes mappings to runtime functions only (e.g., function 117) and a runtime bypass vtable that includes mappings to driver functions (e.g., function 114). In other examples, there could be a different vtable per runtime object (e.g., created during object creation) or a different vtable per virtual function. In some embodiments, virtual table creation component 201 interacts with driver 112 (e.g., using driver interaction component 204) during its instantiation to obtain the memory addresses of its relevant local functions for use in vtables. In other embodiments, virtual table creation component 201 queries driver 112 (e.g., using driver interaction component 204) after its instantiation to obtain the memory addresses of its relevant local functions for use in vtables.

Application interface component 202 represents an interface (e.g., API, ABI) for interacting with applications, such as application 113. In examples, application interface component 202 provides endpoints for application 113 to request objects, such as the example CommandList object, and returns requested objects to application 113 (e.g., by reference to a memory address of that object within loaded runtime 111′).

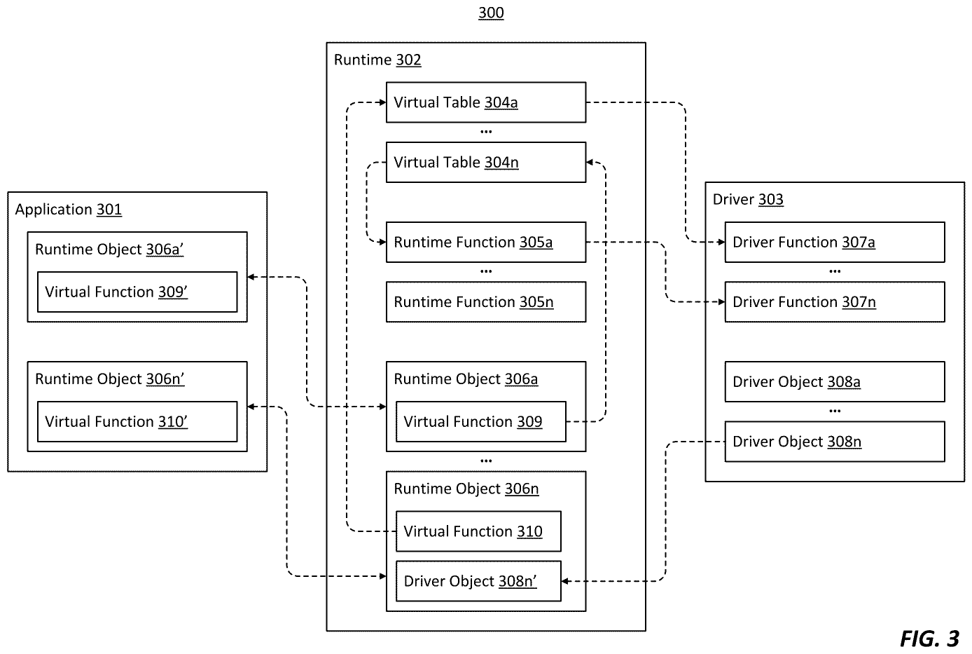

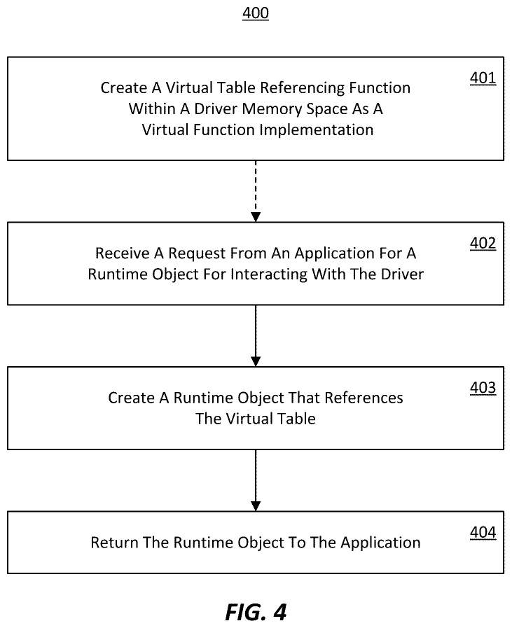

In embodiments, an object creation component 203 creates objects requested by application 113. As will be described in connection with FIGS. 3 and 4, this can include creating an object that includes a virtual function, and that refers to a custom vtable that maps the virtual function to a function (e.g., function 114) within loaded driver 112′. This can include creating an object that includes a reference to driver-specific context, such as object 115.

In embodiments, a driver interaction component 204 interacts with loaded driver 112′ in various ways. As alluded to in the foregoing description of virtual table creation component 201, this may include interacting with loaded driver 112′ to obtain the memory addresses of various internal driver functions, such as function 114. Additionally, in connection with the operation of object creation component 203 to create a runtime object (e.g., object 118), driver interaction component 204 may interact with loaded driver 112′ to request the creation of a corresponding driver-specific object (e.g., object 115) and to obtain a memory address of that driver-specific object (e.g., for inclusion in object 118).

FIG. 3 illustrates an example 300 of a runtime translating calls from an application to a driver. In particular, example 300 includes application 301 (e.g., application 113), runtime 302 (e.g., runtime component 111/loaded runtime 111′), and driver 303 (e.g., driver 112/loaded driver 112′). In example 300, runtime 302 includes a plurality of virtual tables, virtual table 304a to virtual table 304n; a plurality of runtime functions, runtime function 305a to runtime function 305n; and a plurality of runtime objects, runtime object 306a to runtime object 306n. Application 301 includes runtime object 306a′ and runtime object 306n′, e.g., references to runtime object 306a and runtime object 306n, respectively. Driver 303 includes a plurality of driver functions, driver function 307a to driver function 307n; and a plurality of driver objects, driver object 308a to driver object 308n.

Example 300 includes examples of both i) a conventional call translation that includes runtime processing and ii) the new call translation described herein that enables an application to call directly into a driver.

In an example of a conventional call translation, application 301 has obtained runtime object 306a′, e.g., a reference to runtime object 306a, from runtime 302. Runtime object 306a includes a virtual function 309, shown as virtual function 309′ at runtime object 306a′. As indicated by broken lines connecting runtime object 306a′, runtime object 306a, virtual table 304n, runtime function 305a, and driver function 307n, when application 301 calls virtual function 309′, virtual table 304n maps virtual function 309 to runtime function 305a, which is internal to runtime 302. Then, after performing some processing, runtime function 305a calls driver function 307n. Thus, while adding the benefit of processing by runtime function 305a, the call by application 301 includes a call to runtime 302 (e.g., execution of runtime function 305a).

In an example of bypassing a runtime and calling directly into a driver, application 301 also has obtained runtime object 306n′, e.g., a reference to runtime object 306n, from runtime 302. Runtime object 306a includes a virtual function 310, shown as virtual function 310′ at runtime object 306n′. As indicated by broken lines connecting runtime object 306n′, runtime object 306n, virtual table 304a, and driver function 307a, when application 301 calls virtual function 310′, virtual table 304a maps virtual function 310 directly to driver function 307a. Thus, the call by application 301 excludes code execution by runtime 302 (e.g., there is no function execution at runtime 302). Notably, runtime object 306n also references driver object 308n (shown as driver object 308n′ within runtime object 306n). Thus, when application 301 calls driver function 307a, driver 303 can utilize driver object 308n for local driver context relevant to runtime object 306n.

Embodiments are now described in connection with FIG. 4, which illustrates a flow chart of an example method 400 for creating a runtime object to bypass a runtime and call directly into a driver. In embodiments, instructions for implementing method 400 are encoded as computer-executable instructions (e.g., runtime component 111) stored on a computer storage medium (e.g., storage medium 104) that are executable by a processor (e.g., processor system 102) to cause a computer system (e.g., computer system 101) to perform method 400.

The following discussion now refers to a method and method acts. Although the method acts are discussed in specific orders or are illustrated in a flow chart as occurring in a particular order, no order is required unless expressly stated or required because an act is dependent on another act being completed before the act being performed.

Referring to FIG. 4, in embodiments, method 400 comprises act 401 of creating a virtual table referencing a function within a driver memory space as a virtual function implementation. In some embodiments, act 401 comprises creating a virtual function table, the virtual function table mapping a virtual function to a first memory address within a second memory space of the driver, wherein the first memory address corresponds to a function implementation by the driver. For example, virtual table creation component 201 creates virtual table 304a, which maps virtual function 310 to driver function 307a. Notably, a virtual table can comprise a plurality of mappings, so in embodiments, the virtual function table may map each of a plurality of virtual functions to a different memory address within the second memory space of the driver.

Notably, a broken arrow connects act 401 to act 402. This indicates that act 401 may not necessarily occur before act 402. In various examples, virtual table creation component 201 may create virtual table 304a at instantiation of driver 303, at creation of runtime object 306n, or at some other time in between. In these various examples, the runtime may receive the first memory address during initialization of the driver, the runtime may receive the first memory address based on a call to the driver, the runtime may create the virtual function table after a call from the application for the runtime object, or the runtime may create the virtual function table during initialization of the runtime.

Regardless of the timing of act 401, method 400 also comprises act 402 of receiving a request from an application for a runtime object for interacting with the driver. In some embodiments, act 402 comprises receiving a call from an application, the call requesting a runtime object. In embodiments, the runtime object includes a virtual function for issuing a command to a driver via the runtime. For example, driver interaction component 204 receives a call from application 301, requesting a runtime object. In one example, the runtime is D3D, and the runtime object is a “command list” object that identifies a plurality of commands the driver can execute, at least one command callable via the virtual function. In various examples, the driver is a graphics processing unit driver, an audio driver, or a storage driver. In some embodiments, receiving the call from the application comprises receiving the call via a component object model (COM) interface, and the runtime object is a COM object. However, other interfaces may be operable with the embodiments herein.

Method 400 also comprises act 403 of creating a runtime object that references the virtual table. In some embodiments, act 403 comprises creating a runtime object that includes a first member comprising a first pointer to a virtual function table within a memory space of the runtime. For example, based on the call in act 402, object creation component 203 creates runtime object 306 n, which includes a reference to virtual table 304a, which maps virtual function 310 to driver function 307a. In some implementations, this reference is a pointer to virtual table 304a, and the pointer is the first member of the runtime object's structure (e.g., immediately following the object's ‘this’pointer). However, depending on implementation, such as the ABI guaranteed by driver interaction component 204, the pointer could be in a different location of the runtime object's structure, or the runtime object may actually include the virtual table itself (rather than a reference to the virtual table).

In some embodiments, act 403 comprises creating a runtime object that includes a second member comprising a second pointer to a second memory address within the second memory space of the driver, the second memory address corresponding to an internal driver object corresponding to the runtime object. For example, object creation component 203 also includes, within runtime object 306n, a pointer to driver object 308n within driver 303. In some implementations, this pointer to driver object 308n is the second member of the runtime object's structure (e.g., immediately following the pointer to virtual table 304a). However, depending on implementation, such as the ABI guaranteed by driver interaction component 204, the pointer could be in a different location of the runtime object's structure.

In some embodiments, object creation component 203 utilizes driver interaction component 204 to obtain the pointer to driver object 308n. For example, using object creation component 203, object creation component 203 may request that driver 303 create an object corresponding to runtime object 306n. Based on this request, driver 303 creates driver object 308n and returns the pointer to driver object 308n. Thus, in some embodiments, method 400 also comprises, based on receiving the call from the application, calling the driver with a request for creating the internal driver object, and receiving the second memory address from the driver.

Method 400 also comprises act 404 of returning the runtime object to the application. In some embodiments, act 404 comprises returning, to the application, a third memory address corresponding to the runtime object. For example, application interface component 202 returns a memory address corresponding to runtime object 306n to application 301, enabling application 301 to call virtual function 310′ and reach driver function 307a directly.

Accordingly, disclosed are methods and systems for creating a runtime object for bypassing a runtime and calling directly into a driver. A method includes receiving a call from an application requesting a runtime object, which includes a virtual function for issuing commands to a driver via the runtime. The method also includes creating the runtime object with a first member containing a pointer to a virtual function table in the runtime's memory space. This table maps the virtual function to a memory address in the driver's memory space, corresponding to a function implementation by the driver. Additionally, a second member includes a pointer to another memory address in the driver's memory space, corresponding to an internal driver object related to the runtime object. The method also includes returning a memory address corresponding to the runtime object to the application.

Alternatively or in addition to the other examples described herein, examples include any combination of the following:

Clause 1. A method implemented by a runtime in a computer system that includes a processor system, comprising: receiving a call from an application, the call requesting a runtime object; creating the runtime object, the runtime object including: a first member comprising a first pointer to a virtual function table within a memory space of the runtime, the virtual function table mapping a virtual function for issuing a command to a driver via the runtime to a first memory address within a second memory space of the driver, the first memory address corresponding to a function implementation by the driver; and a second member comprising a second pointer to a second memory address within the second memory space of the driver, the second memory address corresponding to an internal driver object corresponding to the runtime object; and returning, to the application, a third memory address corresponding to the runtime object.

Clause 2. The method of clause 1, wherein the runtime object is a command list object that identifies a plurality of commands the driver can execute, at least one command callable via the virtual function.

Clause 3. The method of any of clause 1 or 2, wherein the driver is a graphics processing unit driver, an audio driver, or a storage driver.

Clause 4. The method of any of clause 1 to 3, wherein the method further comprises, based on receiving the call from the application: calling the driver with a request for creating the internal driver object; and receiving the second memory address from the driver.

Clause 5. The method of any of clause 1 to 4, wherein the runtime creates the virtual function table after the call from the application.

Clause 6. The method of any of clause 1 to 4, wherein the runtime creates the virtual function table during initialization of the runtime.

Clause 7. The method of any of clause 1 to 6, wherein the runtime receives the first memory address during initialization of the driver.

Clause 8. The method of any of clause 1 to 7, wherein receiving the call from the application comprises receiving the call via a component object model (COM) interface.

Clause 9. The method of clause 8, wherein the runtime object is a COM object.

Clause 10. The method of any of clause 1 to 9, wherein the virtual function table maps each of a plurality of virtual functions to a different memory address within the second memory space of the driver.

Clause 11. A computer system, comprising: a processor system; and a computer storage medium that stores computer-executable instructions representing a runtime, and that are executable by the processor system to at least: create a virtual function table within a first memory space of the runtime, the virtual function table mapping a virtual function to a first memory address within a second memory space of a driver, the first memory address corresponding to a function implementation by the driver; receive a call from an application, the call requesting a runtime object, the runtime object including the virtual function for issuing a command to the driver via the runtime; create the runtime object, the runtime object including: a first member comprising a first pointer to the virtual function table; and a second member comprising a second pointer to a second memory address within the second memory space of the driver, the second memory address corresponding to an internal driver object corresponding to the runtime object; and return, to the application, a third memory address corresponding to the runtime object.

Clause 12. The computer system of clause 11, wherein the runtime object is a command list object that identifies a plurality of commands the driver can execute, at least one command callable via the virtual function.

Clause 13. The computer system of any of clause 11 or 12, wherein the driver is a graphics processing unit driver, an audio driver, or a storage driver.

Clause 14. The computer system of any of clause 11 to 13, wherein the computer-executable instructions are also executable, based on receiving the call from the application, to: call the driver with a request for creating the internal driver object; and receive the second memory address from the driver.

Clause 15. The computer system of any of clause 11 to 14, wherein the runtime creates the virtual function table during initialization of the runtime or after the call from the application.

Clause 16. The computer system of any of clause 11 to 15, wherein the runtime receives the first memory address during initialization of the driver.

Clause 17. The computer system of any of clause 11 to 16, wherein receiving the call from the application comprises receiving the call via a component object model (COM) interface.

Clause 18. The computer system of clause 17, wherein the runtime object is a COM object.

Clause 19. The computer system of any of clause 11 to 18, wherein the virtual function table maps each of a plurality of virtual functions to a different memory address within the second memory space of the driver.

Clause 20. A computer storage medium that stores computer-executable instructions representing a runtime, the computer-executable instructions including instructions that are executable by a processor system to at least: create a virtual function table within a first memory space of the runtime, the virtual function table mapping a virtual function to a first memory address within a second memory space of a driver, the first memory address corresponding to a function implementation by the driver; receive a call from an application, the call requesting a runtime object, the runtime object including the virtual function for issuing a command to the driver via the runtime; call the driver with a request for creating an internal driver object corresponding to the runtime object; receive, from the driver, a second memory address within the second memory space of the driver, the second memory address corresponding to the internal driver object; create the runtime object, the runtime object including: a first member comprising a first pointer to the virtual function table; and a second member comprising a second pointer to the second memory address; and return, to the application, a third memory address corresponding to the runtime object.

Embodiments of the disclosure comprise or utilize a special-purpose or general-purpose computer system (e.g., computer system 101) that includes computer hardware, such as, for example, a processor system (e.g., processor system 102) and system memory (e.g., memory 103), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 104). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 106) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more GPUs, one or more NPUs, and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented by a runtime in a computer system that includes a processor system, comprising:
receiving a call from an application, the call requesting a runtime object;
creating the runtime object, the runtime object including:
a first member comprising a first pointer to a virtual function table within a memory space of the runtime, the virtual function table mapping a virtual function for issuing a command to a driver via the runtime to a first memory address within a second memory space of the driver, the first memory address corresponding to a function implementation by the driver; and
a second member comprising a second pointer to a second memory address within the second memory space of the driver, the second memory address corresponding to an internal driver object corresponding to the runtime object; and
returning, to the application, a third memory address corresponding to the runtime object.

2. The method of claim 1, wherein the runtime object is a command list object that identifies a plurality of commands the driver can execute, at least one command callable via the virtual function.

3. The method of claim 1, wherein the driver is a graphics processing unit driver, an audio driver, or a storage driver.

4. The method of claim 1, wherein the method further comprises, based on receiving the call from the application:
calling the driver with a request for creating the internal driver object; and
receiving the second memory address from the driver.

5. The method of claim 1, wherein the runtime creates the virtual function table after the call from the application.

6. The method of claim 1, wherein the runtime creates the virtual function table during initialization of the runtime.

7. The method of claim 1, wherein the runtime receives the first memory address during initialization of the driver.

8. The method of claim 1, wherein receiving the call from the application comprises receiving the call via a component object model (COM) interface.

9. The method of claim 8, wherein the runtime object is a COM object.

10. The method of claim 1, wherein the virtual function table maps each of a plurality of virtual functions to a different memory address within the second memory space of the driver.

11. A computer system, comprising:
a processor system; and
a computer storage medium that stores computer-executable instructions representing a runtime, and that are executable by the processor system to at least:
create a virtual function table within a first memory space of the runtime, the virtual function table mapping a virtual function to a first memory address within a second memory space of a driver, the first memory address corresponding to a function implementation by the driver;
receive a call from an application, the call requesting a runtime object, the runtime object including the virtual function for issuing a command to the driver via the runtime;
create the runtime object, the runtime object including:
a first member comprising a first pointer to the virtual function table; and
a second member comprising a second pointer to a second memory address within the second memory space of the driver, the second memory address corresponding to an internal driver object corresponding to the runtime object; and
return, to the application, a third memory address corresponding to the runtime object.

12. The computer system of claim 11, wherein the runtime object is a command list object that identifies a plurality of commands the driver can execute, at least one command callable via the virtual function.

13. The computer system of claim 11, wherein the driver is a graphics processing unit driver, an audio driver, or a storage driver.

14. The computer system of claim 11, wherein the computer-executable instructions are also executable, based on receiving the call from the application, to:
call the driver with a request for creating the internal driver object; and
receive the second memory address from the driver.

15. The computer system of claim 11, wherein the runtime creates the virtual function table during initialization of the runtime or after the call from the application.

16. The computer system of claim 11, wherein the runtime receives the first memory address during initialization of the driver.

17. The computer system of claim 11, wherein receiving the call from the application comprises receiving the call via a component object model (COM) interface.

18. The computer system of claim 17, wherein the runtime object is a COM object.

19. The computer system of claim 11, wherein the virtual function table maps each of a plurality of virtual functions to a different memory address within the second memory space of the driver.

20. A computer storage medium that stores computer-executable instructions representing a runtime, the computer-executable instructions including instructions that are executable by a processor system to at least:
create a virtual function table within a first memory space of the runtime, the virtual function table mapping a virtual function to a first memory address within a second memory space of a driver, the first memory address corresponding to a function implementation by the driver;
receive a call from an application, the call requesting a runtime object, the runtime object including the virtual function for issuing a command to the driver via the runtime;
call the driver with a request for creating an internal driver object corresponding to the runtime object;
receive, from the driver, a second memory address within the second memory space of the driver, the second memory address corresponding to the internal driver object;
create the runtime object, the runtime object including:
a first member comprising a first pointer to the virtual function table; and
a second member comprising a second pointer to the second memory address; and
return, to the application, a third memory address corresponding to the runtime object.
